(19) United States
(12) Patent Application Publication
(10) Pub. No.: US 2009/0041999 A1
(43) Pub. Date: Feb. 12, 2009

(54) CONSTRUCTIONAL SEALANT MATERIAL

(75) Inventor: Jorn Schroer, Herdecke (DE)

Correspondence Address: Jason H. Vick;Sheridan Ross, PC, Suite # 1200, 1560 Broadway, Denver, CO, 80202, US

(73) Assignee: EWALD DORKEN AG, Herdecke (DE)

(21) Appl. No.: 11/911,994

(22) PCT Filed: Apr. 8, 2006
(86) PCT No.: PCT/EP2006/003235

§ 371 Date: May 20, 2008

(30) Foreign Application Priority Data
Apr. 22, 2005 (DE) 10 2005 019 021.9
Apr. 26, 2005 (DE) 10 2005 019 680.2

(51) Int. Cl. B32B 7/00; B32B 27/00; B32B 9/00

(52) U.S. Cl. 428/219; 428/220

(57) ABSTRACT

The invention relates to a flexible, planar, particularly web-shaped constructional sealant material, preferably for application as masonry wall sealant and/or as horizontal damp-course. According to the invention, a simply produced and perforation-resistant sealing may be provided, whereby the constructional sealant material (1) has a first water-tight sealing layer (2) as the first sealing level and a second water-tight sealing layer (3) as the second sealing level, whereby at least one spacer level (4) is provided between the first sealing level and the second sealing level, by means of which the first sealing layer (2) is mechanically separated from the second sealing layer (3) and the total thickness of the sealing layers is at least 250 μm.

The invention relates to a flexible, planar, particularly sheet-like constructional sealant material, preferably for use as a masonry wall barrier and/or horizontal damp course.

In order to seal constructions, sealants in the form of sealing sheets are used, among other things. Such sealing sheets—provided that they are undamaged—provide a reliable seal for pressure-stable, vertical and horizontal subsurfaces against ground moisture, accumulating and non-accumulating seepage water or against moisture by capillary action.

A source of problems is that relatively harsh conditions are usually prevalent at a construction site. Damage to the seal can easily occur through falling, heavy or sharp-edged objects. Furthermore, particularly horizontal seals can be quickly perforated by construction materials with a rough surface which lie on top of the sealing sheets, so that a secure seal is no longer ensured.

This problem has long been known. In part, the attempt has been made to resolve the problem through the use of relatively thick sealing sheets or through the use of reinforcement layers. A disadvantage here is, however, that thick sealing sheets are not only more difficult to install and to handle, but are also more expensive in view of the use of more material. The same applies to the use of additional reinforcement layers.

It is therefore the object of the present invention to make available a constructional sealant material in the form of sealing sheets which is constructed in as simple manner as possible and can be manufactured cost-effectively and also offers an adequate seal even in consideration of the harsh usage conditions at a construction site.

To achieve the abovementioned object, a constructional sealant material that can be used both as a vertical and horizontal constructional seal is proposed according to the invention which has at least two water-tight sealing layers. The individual sealing layers form sealing levels that are independent of each other so that, when one level is damaged, the other sealing layer is still effective.

It is important, furthermore, that the two sealing layers are separated from each other via at least one spacer level lying between these sealing layers. The inside spacer level provides for a decoupling of the two sealing layers and helps the constructional sealant material to have an overall higher perforation resistance. Namely, it has been discovered with the invention that the layer construction according to the invention with at least two sealing layers that are independent of each other and an intermediate spacer level make the seal capable of withstanding the sorts of external forces that lead to perforation and hence to lack of watertightness in seals of the same thickness but in which only one sealing layer is provided. The reason for this increased perforation resistance lies in the following. If a sharp object falls with considerable weight onto the seal according to the invention, a perforation of the upper sealing layer occurs first. Upon impact of the sharp object onto the upper sealing layer, this sealing layer is virtually split open. This splitting during perforation ends, however, in the spacer layer. Depending on the use of the material in the spacer layer, further energy from the falling object is additionally absorbed and converted into deformation energy. Only after perforation through the spacer level does the sharp object reach the second sealing layer. The kinetic energy of the sharp object is, however, no longer sufficient to split open the second sealing layer as well. By contrast, in a sealing sheet with only one sealing layer, the impacting sharp object splits open the sealing layer and the split continues to the end of this layer, resulting in a perforation. Since the constructional sealant material according to the invention has two sealing layers with the intermediate spacer level, a seal is still ensured even in the event of perforation of a sealing sheet.

By virtue of the aforementioned layered construction, the seal according to the invention can also absorb would-be deformations caused by building subsidence or the penetration of construction materials without affecting the watertightness. Moreover, the layered construction according to the invention is relatively simple, resulting in the seal having a very low materials requirement overall, so that it turns out to be a relatively thin layer material which is easily installed and can be manufactured cost-effectively.

Moreover, it was discovered in connection with the present invention that the total thickness of all sealing layers of the constructional sealant material according to the invention must have a minimum value of 250 μm. If the total thickness of all sealing layers is less than the minimum thickness of at least 250 μm, a minimum load capacity of the constructional sealant material can no longer be guaranteed under the harsh conditions of a construction site. Total thickness of less than 250 μm leads to very thin individual thicknesses of the individual sealing layers, so that perforations can occur even under the slightest of loads on the sheet.

It has been observed in experiments that, in order to meet the usual requirements in construction, the total thickness of the sealing layers should lie between 250 μm and 2500 μm. Preferably, the total thickness of the sealing layers lies between 350 μm and 1200 μm, and particularly in the range between 400 μm and 800 μm. The thickness of the individual sealing layers depends on how many layers the constructional sealant material has in total. The rule here is that, given equal perforation resistance, the total thickness for example in a material with three sealing layers can be lower than in a material with only two sealing layers. Accordingly, given equal perforation resistance in a constructional sealant material with two sealing layers, the total thickness can be 600 μm, whereas in a constructional sealant material with three sealing layers the total thickness is only 520 μm.

It is particularly advantageous that at least one decoupling layer be provided in the spacer level. The decoupling layer then only has the task of decoupling the adjacent sealing layers from each other. Finally, a portion of the kinetic energy contributed by the falling heavy object into the constructional sealant material according to the invention is converted in the decoupling layer into deformation energy, so that the remaining portion of kinetic energy which also acts on the next sealing layer is as small as possible.

It is especially favorable in this context that the decoupling layer be embodied such that the decoupling between the first sealing layer and the second sealing layer takes place within the decoupling layer. This ultimately presupposes the use of an appropriate material which permits decoupling within it. For example, this can be a fleece, a woven fabric, a laid scrim, a textile, a crawling or cold-flowing material (e.g. bitumen or atactic PP), a foam and/or an elastic material. In experiments performed, it has been observed that particularly good decoupling and energy-absorbing effects are achieved if a plastic fleece, preferably made of polypropylene and particularly with a surface weight of between 30 g/m² and 300 m², is used as a decoupling layer.

Since the decoupling takes place within the decoupling layer, it is also possible in this case to connect the sealing layers to the decoupling layer over the entire surface, resulting in a solid interconnecting of the layers. In principle, however, it is also possible that the individual sealing layers be joined to the decoupling layer only partially or over part of the surface, so that a decoupling takes place not only in the decoupling layer itself, but also at the transition from the decoupling layer to the sealing layer as well in the non-connected areas.

Moreover, as will be readily understood, the decoupling layer can be embodied both in a single and in multiple layers, with several layers made of the same or even of different material being usable in the multilayer design. In so doing, the individual layers can be interconnected over part of the surface as well as over the entire surface.

In the embodiments described above, a decoupling layer is provided in the spacer level which can incidentally be watertight but need not be watertight. Alternatively, it is possible in principle to join the two sealing layers particularly merely partially together, with the spacer level then being formed by the particularly unconnected intermediate space between the sealing layers. In this seal, which turns out to have at least two layers, the two sealing layers should, in principle, have a somewhat greater thickness than in the corresponding seal with decoupling layer, since the decoupling layer which otherwise absorbs energy is not provided here. Otherwise, this embodiment yields the same advantages according to the invention.

Both in the embodiment described above without decoupling layer on the spacer level and with decoupling layer, it can be expedient to provide a supplemental reinforcement layer for absorbing deformation energy. The reinforcement layer can be reinforcement plies such as woven fabric, laid scrim, metal foil or expanded metal, for example.

To meet the practical requirements, it is of crucial importance that the constructional sealant material according to the invention be embodied overall such that a perforation test per DIN 16 726 (in the version of December 1986) is passed. This is not the case, for example, with a seal in which the sealing layers do not have the minimum thickness of 250 μm overall. In the invention, in order to meet the usual requirements in construction, the perforation test is passed with a fall height of at least 200 mm, particularly at least 300 mm and preferably at least 400 mm, with the tightness of the constructional sealant material according to the invention being intact after the perforation test using a static water column of at least 1000 mm, particularly at least 1500 mm and preferably at least 2000 mm.

With respect to the material of the sealing layer, it is expedient to use plastic. Polyolefins (preferably polyethylene, EVA or polypropylene), polyester, polyurethane or PVC are particularly suitable here, though it goes without saying that the plastics contain the usual additives, such as stabilizers, colorants, fillers, reinforcement fibers and the like.

The surface weight of a sealing layer should lie between 50 g/m² and 1000 g/m², with the surface weight of 50 g/m² corresponding in polyolefins to a thickness of about 50 μm and the surface weight of 1000 g/m² corresponding to a thickness of about 1 mm. As will be readily understood, when using sealing layers with a low surface weight, a commensurately high number of sealing layers must be provided in order to achieve the minimum thickness of 250 μm as provided according to the invention.

It is also of significance in connection with the present invention that the surface weight of the sealing layers has a minimum value of 220 g/m². It has been determined that, precisely in thin sealing layers made of materials with a density of between 0.6 kg/dm³ to 1.4 kg/dm³ and particularly between 0.8 kg/dm³ and 1.2 kg/dm³, a minimum surface weight of all sealing layers of greater than 220 g/m² should be present in order to achieve a sufficient perforation resistance. Preferably, the surface weight of all sealing layers should lie between 250 g/m² and 2500 g/m², preferably between 350 g/m² and 1200 g/m² and especially preferably between 400 g/m² and 800 g/m².

If decoupling layers are used in the material according to the invention, the minimum total surface weight of the constructional sealant material is 230 g/m². Preferably, the total surface weight of the constructional sealant material should lie between 250 g/m² and 3000 g/m², preferably between 400 g/m² and 1500 g/m² and particularly between 500 g/m² and 1000 g/m².

It is expressly pointed out here that all values which are contained in the aforementioned ranges are expressly comprised by the disclosure without requiring express mention.

Moreover, it is advantageous if the layered composite of the constructional sealant material according to the invention is embodied as a moisture barrier and/or is resistant to bitumen.

In order to structure the manufacturing process as simply as possible, it is expedient to apply the first sealing layer and/or the second sealing layer by means of extrusion coating onto the decoupling layer. If an appropriate decoupling layer is selected, particularly when using a plastic fleece, the extrusion coating results in a solid joint between the decoupling layer and the sealing layer or layers without requiring supplemental adhesion or welding.

Furthermore, it is expedient to provide a structuring or at least an adhesive and/or adhesive layer on at least part of the surface of at least the outside of the constructional sealant material according to the invention. The structuring can be produced, for example, by a fleece-like, fibrous, textile or porous material, adhering particles (e.g. sand), undercuts and/or protrusions. The structuring ensures that a good joint with the ground or wall is produced after application of an appropriate adhesive.

Particularly in the embodiment in which no decoupling layer is provided within the spacer level, it is expedient to profile the insides of the adjacent sealing layers facing each other. By profiling the insides facing each other, the merely partially joined sealing layers are prevented from shifting against each other too easily under a corresponding load. But the profiling of the insides of the adjacent sealing layers facing each other also offers the advantage that the connection to the adjacent layers is improved.

The present invention also relates to a method for the manufacture of a flexible, planar, particularly sheet-like sealing material of the aforementioned type.

A simple and cost-effective possibility for the manufacture of the material according to the invention consists in preferably applying both sealing layers by means of extrusion coating onto the decoupling layer. In this context, in order to have an outside structuring on the sealing layer or layers, a provision can be made that at least one sealing layer is profiled on the outside, particularly by a profiled pressure roller, and is thereby structured.

Instead of the three-layer material described in the foregoing, it is also possible in principle to manufacture a material with more than three layers. The number of layers may be either even or odd. The manufacture of a five- and of a seven-layer material is dealt with in detail in the following. In both cases, a three-layer material is produced in a first manufacturing step as a semi-finished product, with a sealing layer being extruded between two fleece layers such that a joint with a fleece layer is produced on both sides of the sealing layer. For sake of completeness, it shall be pointed out that another material with the same effect can also be used instead of the fleece layer.

To manufacture a five-layer material, a sealing layer is then extruded between the three-layer material and a fleece layer such that a joint is produced with the three-layer material on both sides of the sealing layer on the one hand and with the fleece layer on the other hand.

During manufacture of a seven-layer material, a sealing layer is extruded between two three-layer materials such that a joint is produced with seven-layer material on both sides of the sealing layer.

Instead of the above-described manufacture of the five- or seven-layer material via a three-layer semi-finished product, it is also possible in principle, for example, to manufacture a five-layer material through simultaneous running-in and parallel generation of five layers.

Finally, the present invention also relates to a method for manufacturing a seal with a constructional sealant material of the aforementioned type.

Further features and advantages of the invention follow from the following description of sample embodiments based on the drawing.

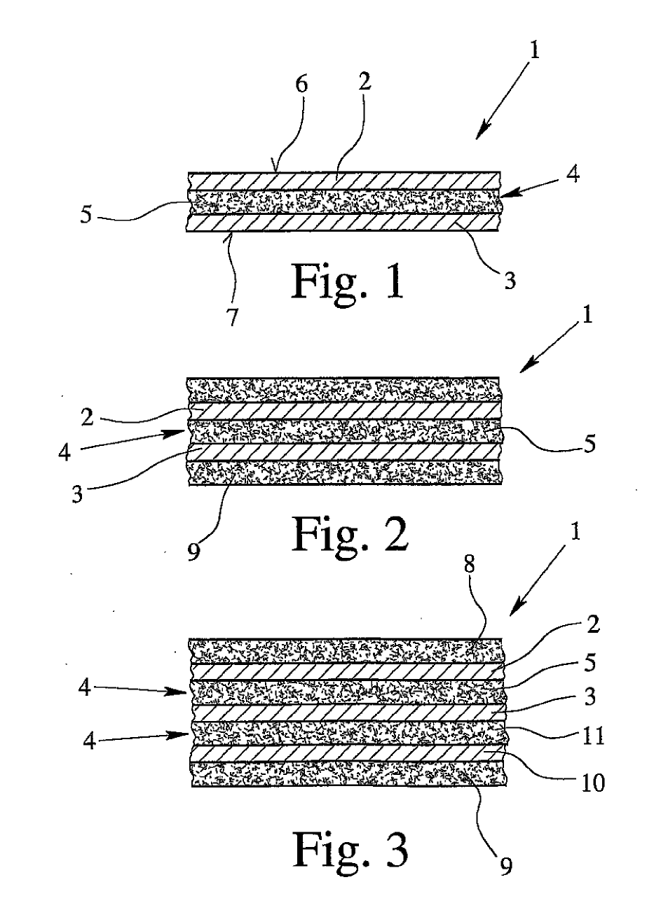

FIG. 1 shows a cross-sectional view of the layered construction of a first embodiment of the constructional sealant material according to the invention,

FIG. 2 shows a cross-sectional view of the layered construction of a second embodiment of the constructional sealant material according to the invention,

FIG. 3 shows a cross-sectional view of the layered construction of a third embodiment of the constructional sealant material according to the invention,

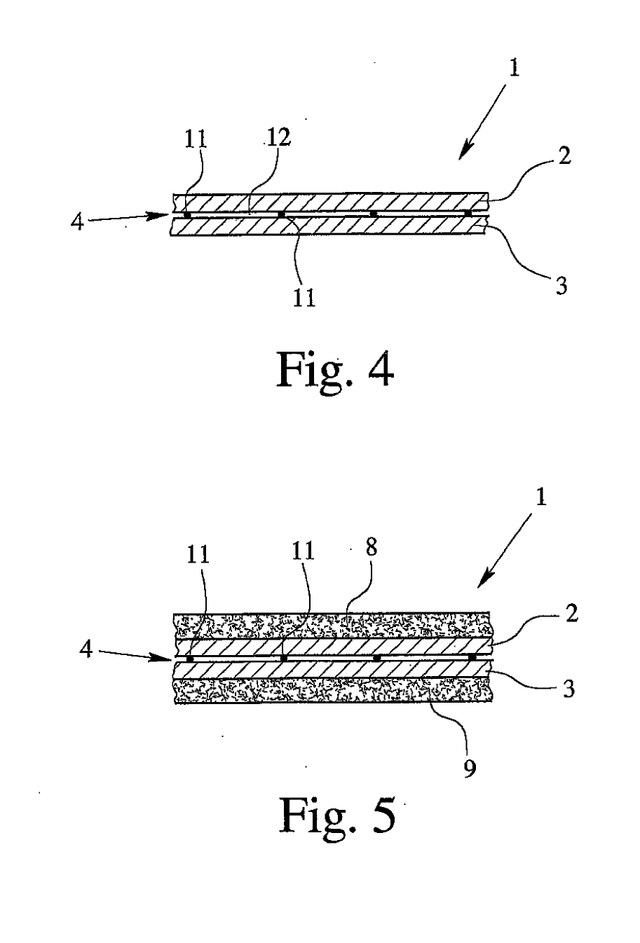

FIG. 4 shows a cross-sectional view of the layered construction of a fourth embodiment of the constructional sealant material according to the invention, and

FIG. 5 shows a cross-sectional view of the layered construction of a fifth embodiment of the constructional sealant material according to the invention.

Represented respectively in the figures are different embodiments of constructional sealant materials 1. The material 1 is a flexible, planar sheet which can be used as a vertical seal, for example as a masonry wall sealant and also as a horizontal seal for the sealing of constructions. Such sheets are usually stored in the form of rolls. The length of the sheets is between 10 m and 50 m, usually 25 m. The width of the rolls can also vary and generally lie between 10 cm and 200 cm. Moreover, the thickness of the constructional sealant material 1 generally lies between 0.25 mm and 2 mm. It shall be noted here that any value within the aforementioned intervals is possible without requiring express mentioned.

In the embodiment depicted in FIG. 1, the constructional sealant material 1 has a first watertight sealing layer 2 and a second watertight sealing layer 3. The two sealing layers 2, 3 are each foils made of LDPE. In the embodiment shown, the first sealing layer 2 has a surface weight of 300 g/m², whereas the second sealing layer 3 has a surface weight of 250 g/m². The thickness of the first sealing layer 2 therefore has a thickness of about 300 μm, whereas the thickness of the second sealing layer 3 is about 250 μm, resulting in a total thickness of the two sealing layers 2, 3 of about 550 μm.

It should be pointed out here that, as will be readily understood, it is also possible in principle for the two sealing layers 2, 3 to each have the same surface weight and the same thickness.

Located between the two sealing layers 2, 3, each of which forms a sealing level, is an internal spacer level 4. The spacer level 4 here has a decoupling layer 5 which is a polypropylene fleece with a surface weight of 100 g/m². The thickness of the decoupling layer 5 is about 700 μm.

It is not shown that the two sealing layers 2, 3 are structured or profiled on their outer sides 6, 7.

The embodiment depicted in FIG. 2 differs from the embodiment depicted in FIG. 1 in that fleece layers 8, 9 are respectively provided as outer layers. The surface weight of these fleece layers 8, 9 is lower than that of the decoupling layer 5 and is about 70 g/m² here.

A seven-layer constructional sealant material 1 is shown in FIG. 3. The sequence of layers alternates between sealing layers 2, 3, 10 and fleece layers 5, 8, 9 and 11. Due to the two fleece layers 5, 11 between the individual sealing layers, the present constructional sealant material 1 has two spacer levels 4.

The embodiments depicted in FIGS. 4 and 5 differ from the embodiments depicted in FIGS. 1 and 3 in that no decoupling layer is provided in the spacer level 4. The sealing layers 2, 3 are partially joined together via corresponding connecting areas 11. The connecting areas 11 can be adhesive bonds or welds. It is possible here in principle that the connecting areas, independently of the type of their manufacture, are embodied such that they form bonds that are partially stronger and partially weaker. The connecting areas 11 can, for example, be distributed as points in the manner of a raster or linearly in the manner of a lattice over the surface, with the connecting proportion of the total surface being less than 20% and particularly less than 10%. Here, the spacer level 4 is formed by the unconnected free and intermediate space 12 provided between the sealing layers 2, 3. The use of a lattice offers the advantage that continuous longitudinally and transversely running sealing sections are produced, so that moisture cannot get through the layered composite from one longitudinal side of the sheet to the other. In the case of an upper-side perforation as well, for example, no water is able to escape through the spacer level.

Moreover, the sample embodiment depicted in FIG. 4 corresponds to that depicted in FIG. 1 under omission of the decoupling layer 5, whereas the sample embodiment depicted in FIG. 5 corresponds to that depicted in FIG. 2, also under omission of the decoupling layer 5.

It is not shown that it is possible in principle to provide one or more additional reinforcement layers in each of the depicted embodiments. The reinforcement layer also serves to absorb kinetic energy and to convert it into deformation energy. Such a layer can be provided both on the outside and at any place inside.

The manufacture of a three-layer material commensurate with FIG. 1 is done such that a film of LDPE with a surface weight of 300 g/m² is produced in a first work step using an extrusion facility. During the process, a 100 g/m² polypropylene needle fleece is run in and joined at the surface with the LPDE melt. In a second work step, the first work step is coated on the fleece side with 250 g/m LDPE to produce the second sealing layer 3. During the manufacture of the material 1, the melt is profiled using a structured pressure roller.

To manufacture a seven-layer material according to FIG. 3, a film of 160 g/m² EVA copolymer (ethylene vinyl acetate) with a 28% VA content is extruded using an extrusion facility between two thermally attached polypropylene fleeces (each 70 g/m²) such that they are joined at the surface with the EVA. In a second work step, a film of 200 g/m² EVA copolymer with a 28% VA content is extruded between two three-layer materials produced in the first work step such that the fleece surfaces are joined with the EVA.

In the seven-layer material described above, the entire thickness of the sealing material is 520 μm. Such a material with three sealing layers performs better than a material with only two sealing layers and a total thickness of 520 μm and, particularly, better than a material with only one sealing layer of the same layer thickness.

After manufacture, the material 1 according to the invention is rolled up onto rollers having the appropriate length and can be laid out subsequently.

In order to produce a large-area seal, the material can be welded or adhered. Particularly in the case of an adhesive bond, longitudinally-running adhesive edges should be provided.

1. Flexible, planar, particularly sheet-like constructional sealant material, preferably for use as a masonry wall barrier and/or horizontal damp course, with at least one first watertight sealing layer as a first sealing level and a second watertight sealing layer as a second sealing level, with at least one inside spacer level being provided between the first sealing level and the second sealing level via which the first sealing layer is decoupled from the second sealing layer, and with the total thickness of the sealing layers being at least 250 μm.

2. Constructional sealant material as set forth in claim 1, wherein the total thickness of the sealing layers lies between 250 μm and 2500 μm, preferably between 350 μm and 1200 μm and particularly in the range between 400 μm and 800 μm.

3. Constructional sealant material as set forth in claim 1, wherein at least one decoupling layer is provided in the spacer level and that the decoupling layer serves to convert kinetic energy into deformation energy upon perforation of a sealing layer.

4. Constructional sealant material as set forth in claim 1, wherein the decoupling layer is embodied such that the decoupling between the first sealing layer and the second sealing layer takes place within the decoupling layer.

5. Constructional sealant material as set forth in claim 1, wherein the decoupling layer has a fleece, a woven fabric, a laid scrim, a textile, a crawling or cold-flowing material, a foam and/or an elastic material.

6. Constructional sealant material as set forth in claim 1, wherein the decoupling layer is designed to be multi-layered.

7. Constructional sealant material as set forth in claim 1, wherein the decoupling layer is embodied as a plastic fleece, preferably of polypropylene, and particularly with a surface weight of between 30 g/m² and 300 g/m².

8. Constructional sealant material as set forth in claim 1, wherein the first sealing layer and the second sealing layer are joined over their entire surfaces with adjacent layers.

9. Constructional sealant material as set forth in claim 1, wherein the first sealing layer and the second sealing layer are partially joined together and that the decoupling layer has a free space between the sealing layers.

10. Constructional sealant material as set forth in claim 1, wherein at least one reinforcement layer is provided.

11. Constructional sealant material as set forth in claim 1, wherein the sealing material is embodied such that a perforation test per DIN 16 726 is passed.

12. Constructional sealant material as set forth in claim 11, wherein the perforation test with a fall height of at least 200 mm, particularly of at least 300 mm and preferably at least 400 mm, is passed.

13. Constructional sealant material as set forth in claim 11, wherein the seal of the constructional sealant material is intact after the perforation test with a static water column of at least 1000 mm, particularly of at least 1500 mm and preferably of at least 2000 mm.

14-15. (canceled)

16. Constructional sealant material as set forth in claim 1, wherein the total surface weight of all sealing layers is at least 220 g/m², preferably between 250 g/m² and 2500 g/m², more preferably between 350 g/m² and 1200 g/m² and particularly between 400 g/m² and 800 g/m².

17. Constructional sealant material as set forth in claim 1, wherein the total surface weight of the constructional sealant material is at least 230 g/m², preferably between 250 g/m² and 3000 g/m², more preferably between 400 g/m² and 1500 g/m² and particularly between 500 g/m² and 1000 g/m².

18. Constructional sealant material as set forth in claim 1, wherein the layered composite of the constructional sealant material is embodied as a moisture barrier and/or is resistant to bitumen.

19. Constructional sealant material as set forth in claim 1, wherein the sealing layer is applied to the decoupling layer by means of extrusion coating.

20. Constructional sealant material as set forth in claim 1, wherein a structuring, particularly a fleece-like, fibrous, textile or porous material, adhering particles, undercuts and/or, at least on part of the surface, protrusions, and/or an adhesion promoter and/or an adhesive layer is provided on at least one outer side of the constructional sealant material.

21. Constructional sealant material as set forth in claim 1, wherein the inner sides of adjacent sealing layers facing each other are profiled.

22-23. (canceled)
